(19) United States
(12) Patent Application Publication
(10) Pub. No.: US 2006/0223595 A1
(43) Pub. Date: Oct. 5, 2006

(54) Folder-type portable communication device having sliding display unit

(75) Inventor: Young S. Kim, Los Altos, CA (US)

Correspondence Address: DILWORTH & BARRESE, LLP, 333 EARLE OVINGTON BLVD., UNIONDALE, NY, 11553, US

(73) Assignee: Samsung Electronics Co., Ltd., Gyeonggi-do (KR)

(21) Appl. No.: 11/355,266

(22) Filed: Feb. 15, 2006

(30) Foreign Application Priority Data
Apr. 4, 2005 (KR) 27985/2005

(51) Int. Cl. H04M 1/00

(52) U.S. Cl. 455/575.3

(57) ABSTRACT

Disclosed is a portable communication device having a sliding display unit. The portable communication device has a body, a folder which rotates about a hinge axis to be folded or unfolded with respect to the body, a sliding display unit which is folded or unfolded together with the folder with respect to the body and which can slide in a longitudinal direction of the folder so as to open and close a region of an inner surface of the body or the folder, and a hinge unit for pivotably connecting the folder to the body.

### PRIORITY

This application claims priority to an application entitled “Folding-Type Portable Communication Device” filed with the Korean Intellectual Property Office on Apr. 4, 2005 and assigned Serial No. 2005-27985, the contents of which are incorporated herein by reference.

### BACKGROUND OF THE INVENTION

1. Field of the Invention

The present invention relates to portable communication devices including cellular phones, Personal Digital Assistants (referred to as PDA), Personal Communication System (referred to as PCS) phones, camera phones, game phones and the like, and more particularly to portable communication devices having a sliding display unit which can be used for a chatting mode and a game mode.

2. Description of the Related Art

In general, the term “a portable communication device” means an electronic device which a user can carry with him/her while communicating with another user wirelessly. In consideration of portability, the trend in the design of such a portable communication device has been towards compactness, slimness and lightness, but also towards providing multimedia capabilities to allow the user to pursue a wider variety of functions. In particular, future portable communication devices will be not only used for many functions while still being compact and light, but will also be modified to be suitable for functioning in a multimedia environment and for providing Internet access and functions.

Conventional portable communication devices may be classified into various types according to their appearance, such as bar-type portable communication devices, flip-type portable communication devices, and folder-type portable communication devices. The bar-type portable communication device has a single housing shaped like a bar. The flip-type portable communication device has a flip panel which is pivotably mounted to a bar-shaped housing by a hinge unit. The folder-type portable communication device has a folder coupled to a single bar-shaped housing by a hinge unit in such a manner that the folder can be rotated in order to be folded or unfolded with respect to the housing.

Further, portable communication devices may be classified as neck wearable type devices and wrist wearable type devices, according to the position at or the way in which a user wears the device. The neck wearable type device is one which a user wears around the neck using a lanyard or necklace, while the wrist wearable type device is one which a user wears around the wrist.

Additionally, portable communication devices may be classified as rotation-type devices and sliding-type devices according to ways of opening and closing the devices. In the rotation-type portable communication device, two housings are coupled to each other in such a manner that one housing rotates to be opened or closed relative to the other while the housings are facing each other. In the sliding-type portable communication device, two housings are coupled to each other in such a manner that one housing slides to be opened or closed relative to the other. The various classifications of portable communication devices are easily understood by those skilled in the art.

Further, each of the conventional portable communication devices is now capable of high-speed data communication as well as voice communication. That is, according to the increase of consumer demands, various services will be provided using wireless communication technology for transmitting and receiving data at a high speed.

It is a present tendency that a camera lens may be mounted to the portable communication device, and that it is possible to transmit image signals and the like. Current portable communication devices may be provided with an embedded or external camera lens module. Therefore, it is possible to perform image communication with a desired partner or to photograph a desired subject.

In the conventional sliding-type portable communication device, however, a housing can slide in only one direction with respect to the other housing and the sliding type portable communication device has only one display unit. Therefore, it is inconvenient for a user to use the conventional portable communication device. In the conventional sliding-type portable communication device, particularly, it is difficult for a user to quickly and accurately operate keys on a body of the portable communication device with both hands in the game mode or the chatting mode. Further, the conventional sliding-type portable communication device has a display unit which typically can display only a portrait mode screen and is limited in displaying a wide landscape mode screen. Thus, there has been a demand for a portable communication device capable of displaying a wide landscape mode screen and having keys which can be operated quickly and accurately.

When consumers purchase communication devices having multimedia functions, the portable communication device tends to have various incorporated functions including a voice communication function, an image communication function, a game player function, a music player function, a TV or video player function, a chatting function, an Internet access function and the like, in addition to the simple voice communication function. When the mobile communication environment changes, it is necessary to provide corresponding various user interfaces. Concerning the convenience of the portable communication device, there is a tendency that a choice of portable communication device is made according to the user interface circumstances.

In the portable communication device, therefore, it is important to provide a convenient user interface including a data input interface and a data output interface, which are essential. Thus, there are many demands for a portable communication device having a display unit which is able to provide user with a convenient user interface environment.

### SUMMARY OF THE INVENTION

Accordingly, the present invention has been made to solve the above-mentioned problems occurring in the prior art, and an object of the present invention is to provide a portable communication device which has a sliding display unit and key pads at both side of the sliding display unit to provide an optimal user interface environment, so that a user can quickly and accurately operate keys while displaying landscape mode images in a chatting mode or a game mode.

Another object of the present invention is to provide a portable communication device which enables a user to easily operate keys with both hands and which has a sliding display unit capable of performing a landscape mode function in order for a user to easily recognize the data displayed on the sliding display unit.

Still another object of the present invention is to provide a portable communication device which includes structural reinforcement portions, specifically a metallic hinge cover and first and second hinge reinforcement portions which can resist impact due to dropping the portable communication device, so as to provide rigidity for a hinge shaft, a body and a folder of the portable communication device.

Still another object of the present invention is to provide a portable communication device which can safely receive the sliding display unit until the sliding display unit completely rotates or slides, so as to provide the reliability for opening and closing operations of the folder, or the sliding movement of the sliding display unit.

Still another object of the present invention is to provide a portable communication device which has a sliding display device including a projection to help the sliding movement of the sliding display device.

Still another object of the present invention is to provide a portable communication device having second and third key pads which a user can easily operate with both hands to input data.

In order to accomplish these objects, there is provided a portable communication device which includes a body; a folder which rotates about a hinge axis to be folded or unfolded with respect to the body; a sliding display unit which is folded or unfolded together with the folder with respect to the body and which can slide in a longitudinal direction of the folder so as to open and close a region of inner surface of the body or the folder; and a hinge unit for pivotally connecting the folder to the body.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view showing a folder-type portable communication device according to a preferred embodiment of the present invention which has a sliding and foldable housing;

FIG. 2 is a front view of the folder-type portable communication device shown in FIG. 1;

FIG. 3 is a side view of the folder-type portable communication device shown in FIG. 1;

FIG. 4 is a perspective view of the folder-type portable communication device according to the preferred embodiment of the present invention, in which a folder of the portable communication device is open; and

FIGS. 5 and 6 are perspective views of the folder-type portable communication device according to the preferred embodiment of the present invention, in which a sliding display unit has slid on a body and a folder of the portable communication device.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein is omitted to avoid making the subject matter of the present invention unclear.

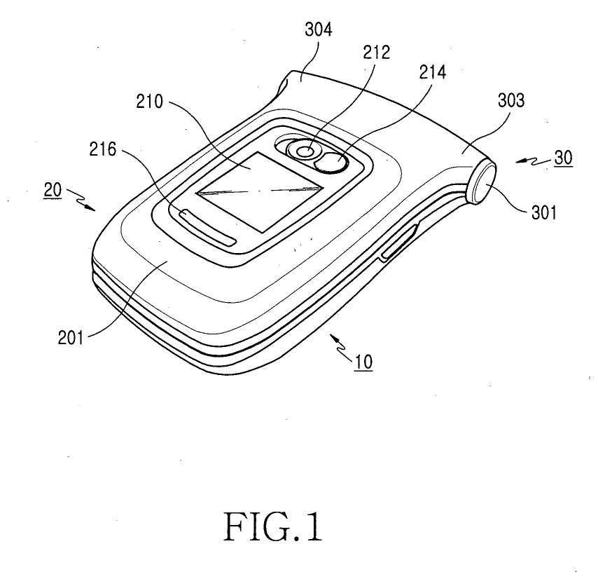

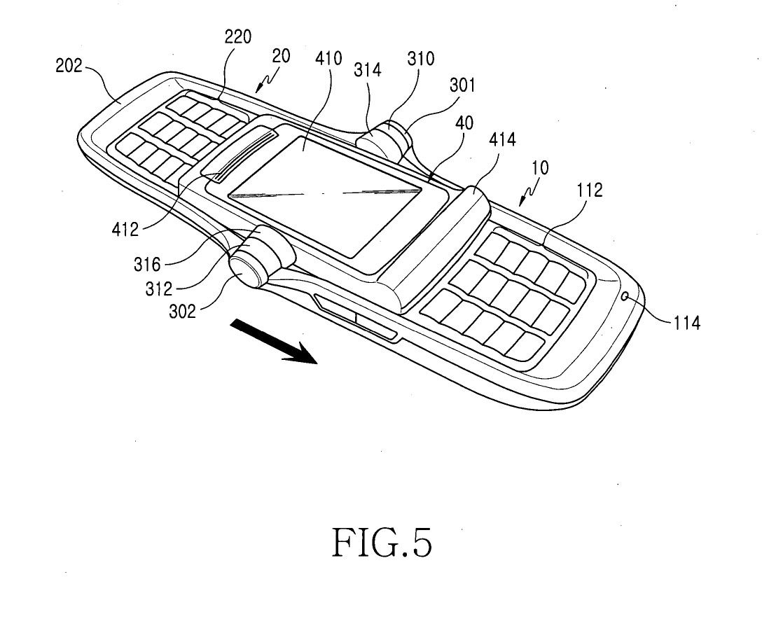

As shown in FIGS. 1, 4 and 5, the portable communication device according to the present invention includes a body 10, a folder 20 which rotates about a hinge axis A (FIG. 4) to be folded or unfolded with respect to the body 10, a sliding display unit 40 which is folded or unfolded together with the folder 20 with respect to the body 10 and which can slide in a longitudinal direction of the folder 20 so as to open and close a region of inner surface 101 or 202 of the body 10 or the folder 20, and a hinge unit 30 for pivotably connecting the folder 20 to the body 10.

After the folder 20 rotates and the sliding display unit 40 then completely slides, the body 10 and the folder 20 may be symmetrically placed on a planar surface. Further, the sliding display unit 40 is positioned between end portions of the body 10 and folder 20 to partially overlap with the body 10 and the folder 20, so that a region near the end of the body 10 on the inner surface 101 of the body 10 is exposed while a region near the end of the folder 20 on the inner surface 202 of the folder is exposed.

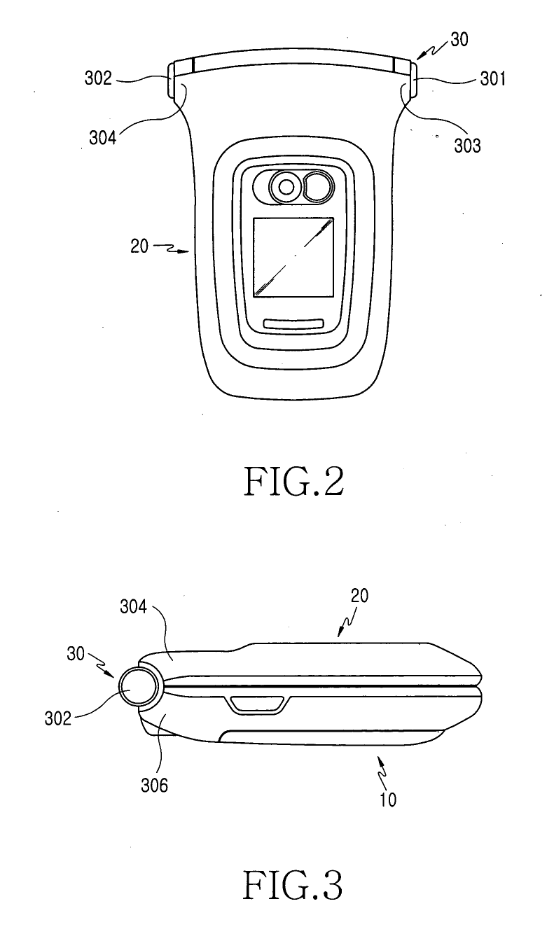

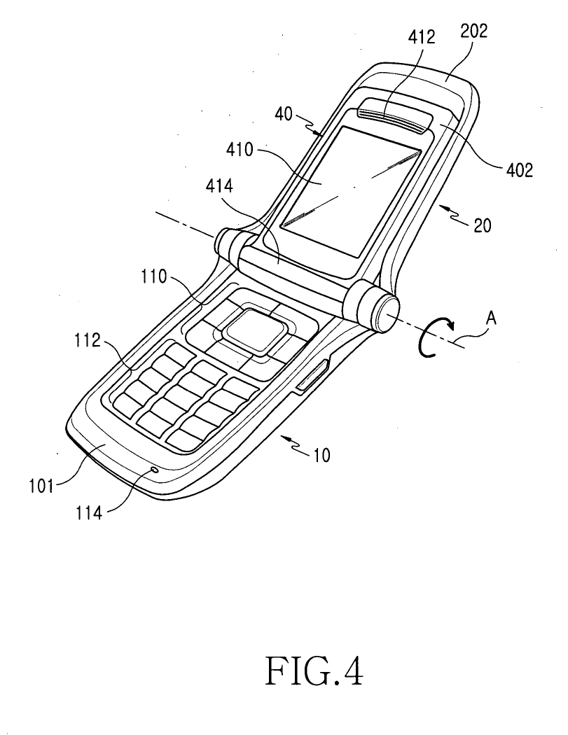

As shown in FIGS. 1 to 3, the folder 20 may be provided with an auxiliary display unit 210, a camera lens 212 near a side of the auxiliary display unit 210 and a call-indication lamp 216 near the other side of the auxiliary display unit 210 which are arranged on an outer surface of the folder 20. Meanwhile, the hinge unit 30 includes a pair of hinge covers 301 and 302 and a pair of first and second hinge reinforcement portions 303, 304, 305 and 306 in order to enhance the structural integrity and avoid weakness due to impact which can be caused by a rotation of the folder 20 with respect to the body 10 or by a drop of the portable communication device. The hinge covers 301 and 302 are preferably made from metal sheets, which are attached to both ends of the hinge unit 30 to supply structural rigidity to the hinge unit 30. Where the hinge unit 30 projects coaxially of the hinge axis A and may be subjected to impact when the portable communication device is dropped, the hinge covers 301 and 302 can protect the hinge unit 30 from the impact applied to the hinge unit 30. Furthermore, the first and second hinge reinforcement portions 303, 304, 305 and 306 include a pair of first hinge reinforcement portions and a pair of second hinge reinforcement portions each of which protrudes in a coaxial direction with the hinge axis A, so as to provide structural rigidity to the body 10 and folder 20. Thereby, the body 10 and the folder 20 can resist a force which may be caused by the over-rotation of the folder 20. In particular, the first hinge reinforcement portions 305 and 306 protrude along the hinge axis A from the body 10 outwardly while the second hinge reinforcement portions 303 and 304 protrude along the hinge axis A from the folder 20. Preferably, the first hinge reinforcement portions 305 and 306 have a gradually decreasing width from the body 10 towards the end of the hinge axis A, while the second hinge reinforcement portions 303 and 304 have a gradually decreasing width from the folder 20 towards the end of the hinge axis A.

As shown in FIGS. 4 to 6, on the inner surface 101 of the body 10, there are disposed a first key pad 110 which is selectively opened and closed as a result of the sliding movement of the sliding display unit 40 after the folder 20 is unfolded, and a second key pad 112 which is always open without regard to the sliding movement of the sliding display unit 40 after the folder 20 is unfolded. A third key pad 220 is disposed on the inner surface 202 of the folder 20, which is selectively opened as a result of the sliding movement of the sliding display unit 40.

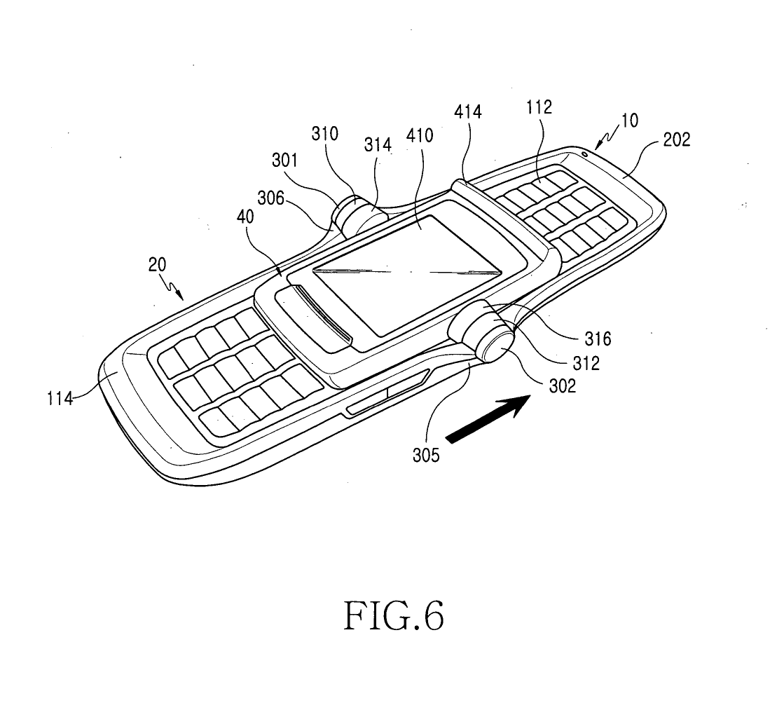

As shown in FIGS. 5 and 6, when the sliding display unit 40 is fully slid, the first key pad 110 is hidden by the sliding display unit 40 while the second and third key pads 112 and 220 are completely open. Thus, the sliding display unit 40 is placed between the second key pad 112 and third key pad 220. Therefore, the user can operate the second and third key pads 112 and 220 with both hands conveniently. As the sliding display unit 40 is positioned between the second and third key pads 112 and 220, further, the user can watch the displayed data in a landscape mode.

As shown in FIGS. 4 to 6, the first and second key pads 110 and 112 are disposed at a desired depth on the inner surface 101 of the body 10 and the third key pad 220 is disposed at a desired depth on the inner surface 202 of the folder 20. As a result, the sliding display unit 40 is safely received in the inner surface of the folder 10. When the folder 10 is fully opened, the sliding display unit 40 can slide on the body 10 and folder 20. As shown in FIG. 4, when the folder is open at a desired angle to communicate with the other, the sliding display unit 40 is still safely received on the inner surface 202 of the folder 20. As shown in FIG. 1, in the case that the folder 20 is completely closed, the sliding display unit 40 is also received on the inner surface 202 of the folder 20.

Further, the sliding display unit 40 rotates with the folder 20. When the rotation of the folder 20 to the open position is completed, the sliding display unit 40 can slide on the folder 20 and the body 10 while facing the inner surfaces of the body 10 and folder 20.

The hinge unit 30 includes outer hinge arms 310 and 312 which protrude from the inner surface 101 of the body 10 and inner hinge arm 314 and 316 which protrude from the inner surface 202 of the folder 20 to be coaxially connected with the outer hinge arms 310 and 312. The outer hinge arms 310 and 312 and the inner hinge arms 314 and 316 form pairs which symmetrically face each other. The pair of the inner hinge arms 314 and 316 support the sliding movement of the sliding display unit 40. Each side of the sliding display unit 40 comes in surface contact with a respective end surface of the inner hinge arms 314 and 316 in order that the sliding display unit 40 is guided and supported by means of the inner hinge arms 314 and 316.

Preferably, the hinge unit 30 has a truncated cone shape. The inner and outer hinge arms in particular have a truncated cone shape.

Preferably, the sliding display unit 40 slides straight, in a plane that is parallel to the plane in which body 10 and folder 20 lie. The sliding display unit 40 includes a projection 414 at an end portion thereof which protrudes perpendicular to a surface of the sliding display unit 40 while extending parallel with hinge axis A to help the sliding movement of the sliding display unit 40. The projection 414 is disposed over the inner surface 101 of the body to be parallel with the hinge axis A. FIGS. 5 and 6 show the portable communication device in which the sliding display unit 40 is sliding on the body 10 and the folder 20. Further, the projection 414 may be disposed in a region of the hinge unit 30. FIG. 4 shows the sliding display unit 40 of which the projection 414 is placed in the region of the hinge unit 30. Of course, the sliding display unit 40 can slide only when the body 10 and the folder 20 are placed in the same plane.

Furthermore, the sliding display unit 40 includes a display screen 410 which is disposed on a surface thereof and a speaker unit 412 which is arranged near the display screen 410. A microphone unit 114 is disposed at an edge of the inner surface 101 of the body 10.

In the sliding display unit 40 as shown in FIG. 4, the first and second key pads 110 and 112 are arranged to face the display screen 410 and the speaker unit 412 adjacent to the hinge axis A. As shown in FIG. 5, the second key pad 112 and the third key pad 220 are respectively arranged on the body 10 and the folder 20 to be symmetric to the sliding display unit 40 when the sliding display unit 40 is slid and positioned at a center portion of the portable communication device.

In the state of FIG. 4, the portable communication device is preferably used in a communication mode. In the state of FIG. 5, the portable communication device is preferably used in a game mode or a chatting mode. In the game mode or the chatting mode, it is often required to operate keys quickly and accurately. Therefore, when the user can operate keys with both hands, accurate and rapid key operation can be achieved.

Preferably, the first key pad 110 is mainly comprised of functional keys. The second key pad 112 preferably consists of numeric keys. The third key pad 220 is preferably a keyboard, for example a QWERTY keypad.

As described above, the portable communication device of the present invention can give the user an optimal user interface environment in the chatting mode or the game mode. Further, the present invention supplies the structural rigidity to the portable communication device so as to resist external impacts due to dropping of the portable communication device. In particular, the portable communication device has a stable structure with respect to the sliding movement of the sliding display unit. Particularly, the present invention permits the sliding display unit to provide a landscape function view in the chatting mode or the game mode, which allows the user to operate the keys with both hands. There are advantages in that since the portable communication device is provided with the hinge reinforcement portion and the metallic hinge cover to protect against damage to the hinge unit caused by dropping the portable communication device. On the other hand, there is another advantage in that the portable communication device reliably secures the sliding movement of the sliding display unit so as to open and close the key pads easily.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A portable communication device comprising:
a body;
a folder which is folded or unfolded with respect to the body;
a sliding display unit which is folded or unfolded together with the folder with respect to the body and which can slide in a longitudinal direction of the folder so as to open and close a region of an inner surface of the body or an inner surface of the folder; and
a hinge unit for pivotally connecting the folder to the body.

2. The portable communication device as claimed in claim 1, wherein the body has a first key pad and a second key pad which are arranged on an inner surface thereof, the first key pad being selectively opened and closed with respect to the sliding movement of the sliding display unit after the folder is unfolded, and a second key pad being always open without regard to the sliding movement of the sliding display unit after the folder is unfolded.

3. The portable communication device as claimed in claim 1, wherein the folder has a third key pad which is disposed on the inner surface of the folder to be selectively opened as a result of the sliding movement of the sliding display unit.

4. The portable communication device as claimed in claim 3, wherein, when the sliding display unit fully slides, the first key pad is hidden by the display unit while the second and third key pads are completely open.

5. The portable communication device as claimed in claim 3, wherein the first and second key pads are disposed at a desired depth on the inner surface of the body and the third key pad is disposed at a desired depth on the inner surface of the folder, so that the sliding display unit is safely received in and slides on the body and folder when the folder is open, and is received in the folder when the folder is fully closed.

6. The portable communication device as claimed in claim 1, wherein the sliding display unit further comprises a speaker unit.

7. The portable communication device as claimed in claim 1, wherein the sliding display unit rotates with the folder while facing the body, and slides on the body and folder after completion of rotation.

8. The portable communication device as claimed in claim 1, wherein the hinge unit includes an outer hinge arm which protrudes from the body and an inner hinge arm which protrudes from the folder to be coaxially connected with the outer hinge arm for supporting the sliding movement of the sliding display unit.

9. The portable communication device as claimed in claim 8, wherein the inner and outer hinge arms have a truncated cone shape.

10. The portable communication device as claimed in claim 1, wherein the hinge unit further comprises first hinge reinforcement portions which project along a hinge axis from sides of the body outwardly and second hinge reinforcement portions which project along the hinge axis from sides of the folder, the first and second hinge reinforcement portions being symmetric to the hinge axis.

11. The portable communication device as claimed in claim 10, wherein the first hinge reinforcement portions have a gradually decreasing width from the body toward the end of the hinge axis, while the second hinge reinforcement portions have a gradually decreasing width from the folder toward the end of the hinge axis.

12. The portable communication device as claimed in claim 1, wherein the sliding display unit further includes a projection at an end portion thereof which protrudes perpendicularly to a surface of the sliding display unit while extending parallel to a hinge axis to help the sliding movement of the sliding display unit, so that the projection is disposed in parallel with the hinge axis in a region of the hinge unit.

13. The portable communication device as claimed in claim 1, wherein the folder has at least of an auxiliary display unit, a camera lens, and a call indication lamp, which are arranged on the inner surface of the folder.

14. The portable communication device as claimed in claim 1, wherein the hinge unit further includes metallic hinge covers at an outmost portion of the hinge unit so as to provide structural rigidity for a hinge axis.

15. The portable communication device as claimed in claim 1, wherein when the sliding display unit fully slides so that the body and folder are horizontal and symmetric to each other, the sliding display unit opens regions of the inner surfaces of the body and folder which are remote from a hinge axis, resulting in being placed between the regions remote from the hinge axis.

16. The portable communication device as claimed in claim 1, wherein the sliding display unit slides linearly.
